(19) United States
(12) Patent Application Publication
(10) Pub. No.: US 2026/0236732 A1
(43) Pub. Date: Aug. 13, 2026

(54) TENSOR MAPPING UNIT FOR A HARDWARE INTEGRATED CIRCUIT

(71) Applicant: Google LLC, Mountain View, CA (US)

(72) Inventors: Yang Yang, Sunnyvale, CA (US); Suyog Gupta, Sunnyvale, CA (US); Vishal Anand, Saratoga, CA (US); Temitayo Fadelu, Mountain View, CA (US); Xiaoxiao Long, San Jose, CA (US)

(21) Appl. No.: 19/154,255

(22) PCT Filed: Feb. 10, 2023
(86) PCT No.: PCT/US2023/012817

§ 371 Date: Aug. 6, 2025

(51) Int. Cl. G06N 3/04

(52) U.S. Cl. CPC G06N 3/04

(57) ABSTRACT

Methods and systems, including computer-readable media, are described for a tensor mapping unit for a hardware integrated circuit configured to accelerate tensor computations for a machine-learning model. The tensor mapping unit is configured to: i) generate tensor element positions for a tensor based on an instruction received from a processing engine of the integrated circuit; ii) determine that a first subset of the tensor element positions is assigned to a first compute tile of the integrated circuit; and iii) generate control signals to obtain a group of inputs from a tile memory of the first compute tile based on the first subset.

### BACKGROUND

This specification generally relates to mapping compute operations to devices of a hardware integrated circuit.

Neural networks are machine-learning models that employ one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing. Different types of neural network architectures can be used to perform a variety of tasks related to classification or pattern recognition, predictions that involve data modeling, and information clustering.

A neural network layer can have a corresponding set of parameters or weights. The weights are used to process inputs (e.g., a batch of inputs) through the neural network layer to generate a corresponding output of the layer for computing a neural network inference. A batch of inputs and set of kernels can be represented as a tensor, i.e., a multi-dimensional array, of inputs and weights. A hardware accelerator is a special-purpose integrated circuit for implementing neural networks. The circuit includes memory with locations corresponding to elements of a tensor that may be traversed or accessed using control logic of the circuit.

### SUMMARY

This document describes techniques for implementing a tensor mapping unit at a special-purpose hardware integrated circuit, such as a hardware accelerator, tensor processing unit, or neural network processor that implements a neural network and other machine-learning algorithms. The tensor mapping unit can be implemented in hardware, software, or both. A hardware architecture of the tensor mapping unit includes a first tensor module and multiple second tensor modules. The first tensor module is external to multiple compute tiles of the special-purpose integrated circuit, whereas a respective second tensor module is included at each of the multiple compute tiles of the integrated circuit.

The tensor mapping unit uses the first tensor module and one or more of the second tensor modules to accelerate a mapping of tensor indices from a logical space to a space after a transformation is applied to an input sample (e.g., an image) before the input sample is processed at the integrated circuit using the tensor mapping unit. The input sample can be an image or a tensor and the transformation an affine transformation. In general, the input sample is a type of machine-learning input (e.g., an audio sample) and the transformation is an operation performed on the input sample as a pre-processing step to computing a model output from the input sample.

One aspect of the subject matter described in this specification can be embodied in an integrated circuit configured to accelerate tensor computations for a machine-learning model implemented at the integrated circuit. The integrated circuit includes a processing engine and a tensor mapping unit. The tensor mapping unit is configured to: i) generate a multiple tensor element positions for a tensor based on an instruction received from the processing engine; ii) determine that a first subset of the multiple tensor element positions is assigned to a first compute tile of the integrated circuit; and iii) generate control signals to obtain a group of inputs from a tile memory of the first compute tile based on the first subset.

These and other implementations can each optionally include one or more of the following features. For example, in some implementations, the tensor mapping unit is configured to generate the multiple tensor element positions by performing an affine transformation on an input image based on the instruction received from the processing engine. In some implementations, the integrated circuit includes multiple compute tiles and the tensor mapping unit is further configured to determine an allocation of different subsets of the multiple tensor element positions to one or more of the multiple compute tiles.

The tensor mapping unit includes a first tensor module that: i) generates the multiple tensor element positions and ii) based on one or more instructions from the processing engine, generates multiple tensor element positions for each of multiple tensors. In some implementations, the tensor mapping unit includes multiple second tensor modules that generate control signals for obtaining data corresponding to the multiple tensor element positions. The multiple tensors are processed at the integrated circuit using each second tensor module and each of the multiple compute tiles.

The tensor mapping unit is configured to generate a tensor mapping table that can include mapping information specific to: i) the multiple tensor element positions; ii) multiple subsets of the multiple tensor element positions; and iii) an assignment of the first subset to the first compute tile. In some implementations, the tensor mapping unit is configured to determine a mapping of a first set of addresses of a virtual address space to a second, different set of addresses of a physical address space. The first tensor module is coupled to the processing engine and is external to each of the multiple compute tiles.

In some implementations, a second tensor module of the multiple second tensor modules is located at each compute tile of the multiple compute tiles included at the integrated circuit. Each second tensor module is configured to access a tile memory of the compute tile that includes that second tensor module; and that second tensor module accesses the tile memory based on a particular subset of the multiple tensor element positions that is assigned to that compute tile.

Each input in the group of inputs can correspond to a respective tensor element position in the first subset; and each element of the tensor corresponds to an input and an address location in a tile memory that stores the input. The multiple tensor element positions can correspond to different dimensions of two or more multi-dimensional tensors; and at least one of the multi-dimensional tensors is an input tensor or a parameter tensor that is processed at the integrated circuit using the processor engine, the tensor mapping unit, and one or more compute tiles.

Another aspect of the subject matter described in this specification can be embodied in a computer-implemented method for accelerating tensor computations for a machine-learning (ML) model implemented on an integrated circuit that includes a processing engine and a tensor mapping unit. The method includes generating, by the processing engine, an instruction that is used to compute an output of the ML model. The instruction is executable at the integrated circuit to cause performance of operations that include: i) generating, by the tensor mapping unit, multiple tensor element positions for a tensor based on the instruction; ii) determining, by the tensor mapping unit, that a first subset of the multiple tensor element positions is assigned to a first compute tile of the integrated circuit; and iii) generating, by the tensor mapping unit, control signals to obtain a group of inputs from a tile memory of the first compute tile based on the first subset.

These and other implementations can each optionally include one or more of the following features. For example, in some implementations, the tensor mapping unit includes multiple second tensor modules and the method further includes: generating, by the multiple second tensor modules, control signals for obtaining data corresponding to the multiple tensor element positions; and processing the multiple tensors at the integrated circuit using each second tensor module and each of the multiple compute tiles.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages. The disclosed techniques efficiently expose cores of a processor engine to a large scratchpad memory that is local to, and distributed across, multiple compute tiles of an integrated circuit. In particular, the disclosed tensor mapping unit exposes tile memory of each compute tile as a scratchpad that is accessible to the processor engine. The tile memory is therefore not restricted to just certain arithmetic operations that are specifically structured and lowered for execution at the tiles.

Rather, this exposure expands and enhances the utility of the tile memory to support a multitude of processor engine operations that may be executed at the integrated circuit. Relatedly, the tensor mapping unit enables cross-complementary support such that resources of the compute tiles can complement processor engine operations and processor engine resources can complement compute tile operations. Cores of the processor engine can be tightly coupled to the tile memory so that the complementary operations occur without expensive data transfer overheads.

In an example system-on-chip (SoC), a transformation (e.g., an affine transformation) may be performed to pre-process an image for a machine-learning workload. For example, the pre-processing can involve resizing or cropping the image before the image undergoes inference computes to recognize one or more objects in the image. Prior systems that include a dedicated hardware accelerator and a general purpose central processing unit (CPU) offload such pre-processing to the CPU. This offloading increases overall compute cycles for a machine-learning task and needlessly consumes CPU and memory resources (e.g., DRAM).

The disclosed tensor mapping unit and associated programming logic allows for improved distribution of tensor data across multiple compute tiles. More specifically, this improved distribution is enabled by efficient and dynamic mapping of a virtual address space of a new processing core(s) to a physical address space of the compute tiles. So, rather than offloading the pre-processing to the CPU and DRAM, the tensor mapping unit and processing core(s) can leverage this address mapping to efficiently pre-process an image locally at a set of compute tiles.

The processor cores and tensor mapping unit can cooperate to immediately remap resized (or pre-processed) image data for an inference compute. For example, after the pre-processing, the SoC can leverage the processor core and tensor mapping unit to automatically reallocate the resized image locally at the compute tiles and then perform intensive neural network computations to generate an image recognition output. Thus, by avoiding the expensive data transfer and resource penalties of offloading and reloading the input data, the SoC can more efficiently accomplish its data transformation and inference computes.

The disclosed techniques allow for even distribution of tensor data across multiple compute tiles. This enables efficient control and status register (CSR) programming for accessing tensors that are evenly distributed across two or more tiles. The programming logic includes an instruction set with byte address mode instructions that enable the processor engine to perform byte addressable accesses against tile memory. This byte-addressing feature enables localized access to various lengths of byte-level data and provides fine-grained tensor access capability to the processor engine.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system that maps portions of a tensor to compute tiles of an integrated circuit.

FIG. 2 is a block diagram of an example computing system with one or more compute tiles for implementing a machine-learning model.

FIG. 3 shows an example architecture for a portion of a tensor mapping unit in a compute tile.

FIG. 4 is a block diagram that shows aspects of a memory mapping process.

FIG. 5 shows examples of a virtual tensor layout and a physical tensor layout.

FIG. 6 shows an example tensor mapping table.

FIG. 7 shows examples of memory regions and a distribution of tensor data in those memory regions.

FIG. 8 is an example process for a tensor mapping operation performed using the example tensor mapping unit.

FIG. 9 illustrates an example of an input tensor, a parameter tensor, and an output tensor.

Like reference numbers and designations in the various drawings indicate like elements.

### DETAILED DESCRIPTION

The system 100 includes a processor engine 102, a tensor mapping unit 104, and one or more compute tiles 106. In some implementations, the processor engine 102 is a general purpose central processing unit (CPU) (e.g., a multi-core CPU). The processor engine 102 can be configured as an instruction and vector data processing engine that processes data obtained from a system memory, such as a dynamic random access memory (DRAM) of a system-on-chip (SoC). In some implementations, system 100 is an SoC of a consumer electronic/mobile device such as a smartphone, tablet, or laptop.

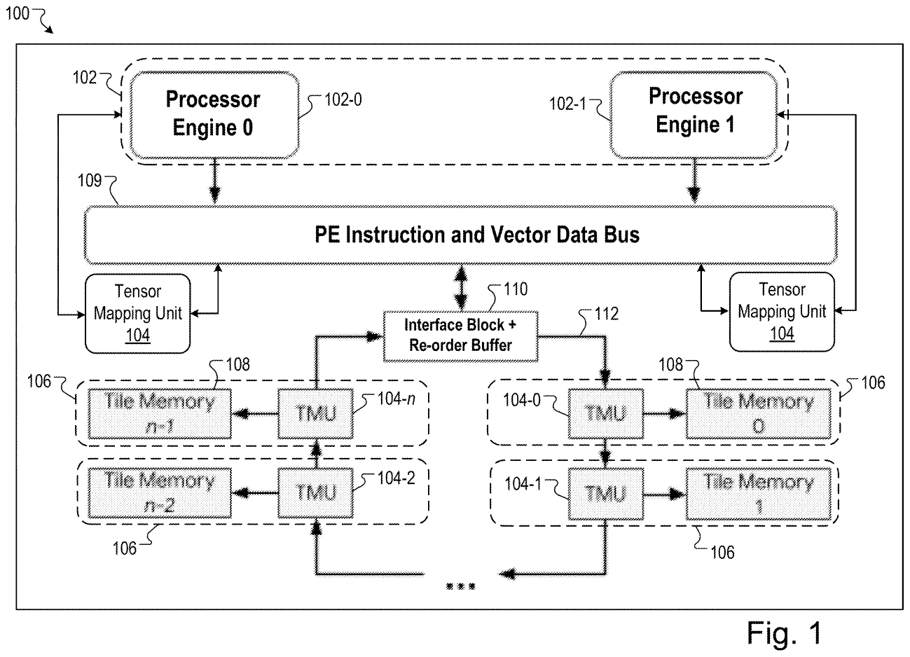

The processor engine 102 can include multiple (e.g., more than two) processor cores. In the example of FIG. 1, processor engine 102 includes a first processor engine/core 102-0 and a second processor engine/core 102-1. In some implementations, first processor engine 102-0 and second processor engine 102-1 are distinct processors, whereas in some other implementations first processor engine 102-0 and second processor engine 102-1 are distinct cores of a single processor.

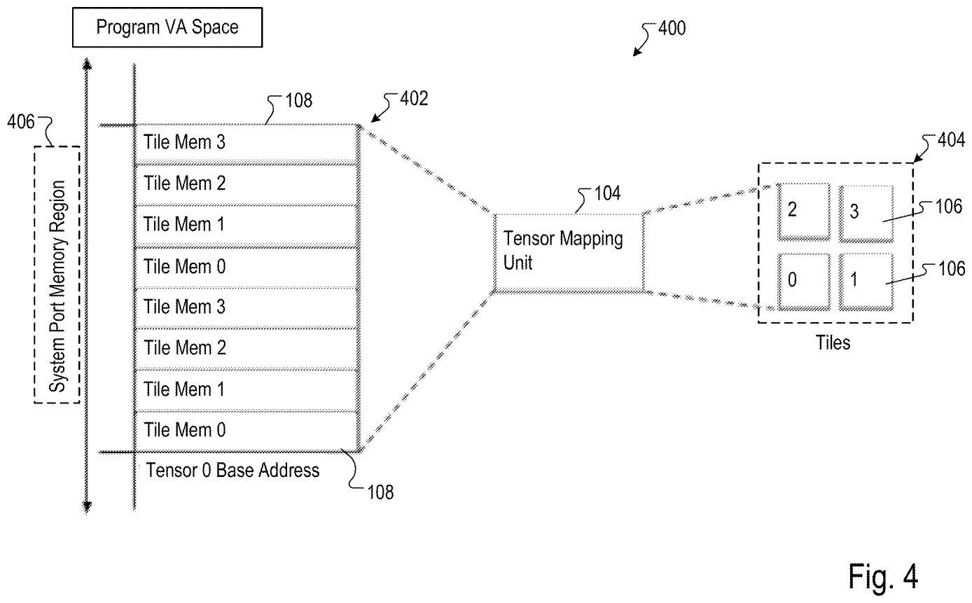

The tensor mapping unit 104 handles address remapping between logical/virtual or physical address spaces of system 100. This is described below with reference to the example of FIG. 4. The tensor mapping unit 104 can be implemented in hardware, software, or both. A hardware architecture of the tensor mapping unit 104 can include a first portion that is external to the compute tiles 106 and a second portion that is local to each of the compute tiles 106.

The first portion is referred to alternatively as a first tensor module, whereas the second portion is referred to alternatively as multiple second tensor modules 104-0, 104-1, 104-2, . . . , 104-n. The first tensor module is coupled to the processor engine 102 and exchanges data communications, such as instructions and requests, with the processor engine 102. In some implementations, the tensor mapping unit 104 includes multiple tensor modules 104-n, where n is an integer greater than or equal to zero or one.

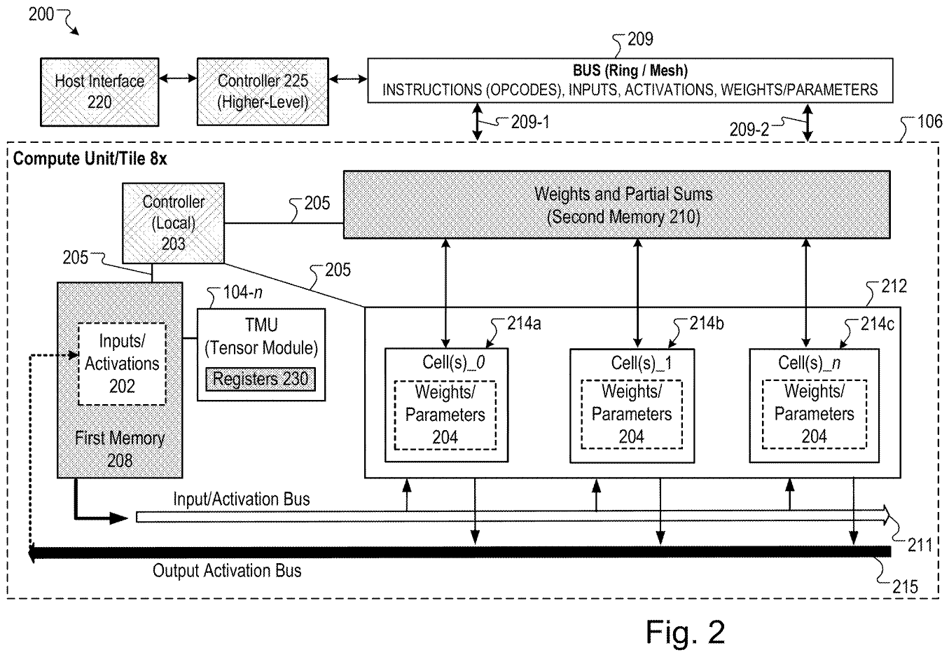

Each of the one or more compute tiles 106 includes a respective tile memory 108 that stores data such as operands for arithmetic and other computational operations performed to execute a machine-learning workload. The compute tiles 106 are described in more detail below with reference to the example of FIG. 2. The system 100 includes a bus 109 and an interface block 110 for routing data communications between the processor engine 102, the tensor mapping unit 104, and each of the one or more of the compute tiles 106.

The bus 109 can be configured as an instruction and vector data bus that cooperates with the interface block 110 (described below) to route instructions and data to each of the multiple compute tiles 106. In some implementations, data traffic is routed and/or managed at bus 109 based on an on-chip communication bus protocol, such as the Advanced extensible Interface (AXI) protocol or other related bus protocols. Data traffic routed via bus 109 include requests that involve tensor data stored at one or more tile memory 108. For example, the requests can be read/load (LD) requests to obtain tensor data from tile memory 108 and write/store (ST) requests to provide tensor data to tile memory 108.

In some implementations, the compute tiles 106 are arranged in a ring configuration and the bus 109 is configured as a ring bus such that a request/response path 112 traverses each of the compute tiles 106. In this implementation, the system 100 can send a request to some (or all) of the tensor modules 104-n at each compute tile 106 over the ring bus 109 and receive a response to a corresponding request over the ring bus 109. In some implementations, the request/response path 112 is non-blocking, which means that a request can continue traversing the ring bus 109 from a first compute tile 106 to a next/second compute tile 106 without waiting for a response from a previous tile 106.

In general, the processor engine 102 uses or generates LD/ST instructions to access tile memory 108 at one or more compute tiles 106. A request can represent, or issue from, a LD/ST instruction. The instruction can target an address range of the tile memory 108 of a particular compute tile 106, where the address range corresponds to a portion, slice, or dimension of a tensor. For example, each compute tile 106 can be assigned one slice of a tensor, where a “slice” can be represented as range of the indices in each dimension of a multi-dimensional tensor. A rank of the slice can be the same as the rank of the multi-dimensional tensor.

In some implementations, when a request corresponding to LD/ST instruction is dispatched, the request is broken down or segmented into one or more 32-byte (32B) requests. Thus, in some cases a single request can result in multiple responses or response packets. In some examples, a single LD/ST instruction can be generated based on Instruction Set Architecture that supports a range of byte granularities. For example, requests associated with a LD/ST instruction can be one-byte requests, 8-byte requests (scalar register), or up to 512-byte requests (vector LD/ST). As indicated above, for requests that are greater than 32 bytes, the processor engine 102 can be configured to break them into multiple requests, where each transaction is less than or equal to 32 bytes.

The bus 109 can route requests and responses to the requests through an example tile memory fabric. In some implementations, the tile memory fabric is a fabric interface with one or more bus lines (e.g., data path 112) that are used to route data for a request and to route data for a response to a request. The request and response traffic traversing the tile memory fabric can be controlled, ordered, and/or managed via control logic of the interface block 110. For example, the interface block 110 can include a reorder buffer to ensure that the responses that are sent back to the processor engine 102 are in the same order as the requests that correspond to the responses.

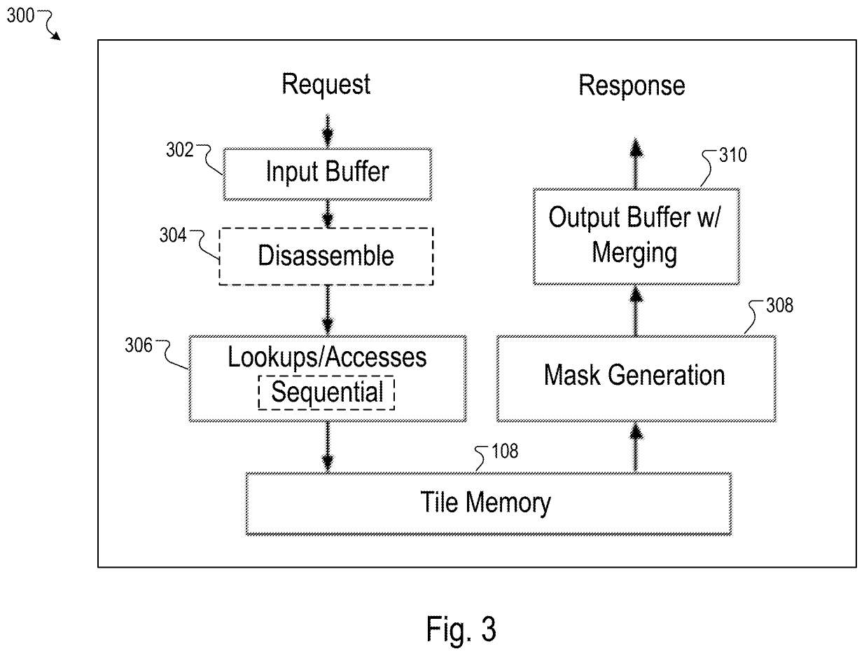

In some implementations, interface block 110 is configured to detect that a response to a particular request has arrived and read (or scan) a mask field in that response to perform any required shifting or positioning operations. For example, the interface block 110 can scan a response, detect the mask field, shift the response data to the appropriate position, and merge the response data with corresponding data from one or more previously received responses. The interface block 110 can perform any required parsing operations in support of scanning or detecting the mask field and shifting the response data. The mask field is described below reference to the example of FIG. 3.

Additionally, this gathering/merging operation can involve at least two parameters: i) num_bits_set (mask) and ii) request_size. When the num_bits_set (mask)==request_size, this indicates that the merging of the response data is complete and a response can be generated and sent back to the processor engine 102.

FIG. 2 is a block diagram of an example computing system 200 for implementing a neural network model at hardware integrated circuit, such as a machine-learning hardware accelerator. In general, computing system 200 is included at computing system 100, for example, as a sub-system of computing system 100. Computing system 200 includes one or more compute tiles 106, a host interface 220, and a higher-level controller 225 (“controller 225”). As described in more detail below, the host interface 220 and controller 225 cooperate to provide datasets and instructions to one or more compute tiles 106 of system 200.

In some implementations, the host interface 220 and the controller 225 are distinct devices, whereas in some other implementations the host interface 220 and the controller 225 are the same device. The host interface 220 and the controller 225 can also perform distinct functions but be integrated in a single device package. For example, the host 220 and controller 225 can form a central processing unit (CPU) that interacts or cooperates with a hardware accelerator that includes the multiple compute tiles 106. In some implementations, the host interface 220, controller 225, and multiple compute tiles 106 are included or formed as different sections on a single integrated circuit die. For example, the host 220, controller 225, and multiple compute tiles 106 can form a special-purpose System-on-Chip (SoC) that is optimized for executing processing machine-learning workloads, including neural network models for image processing applications.

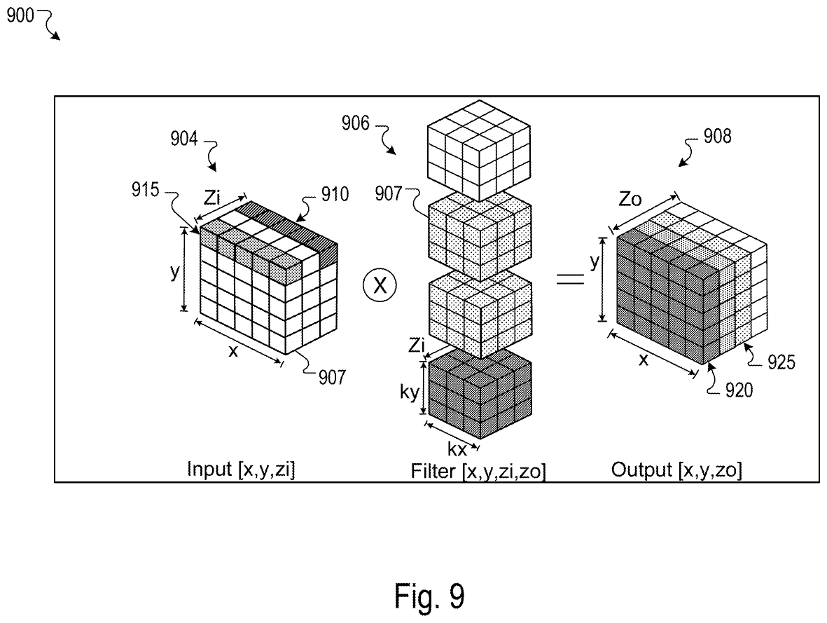

Each compute tile 106 generally includes a controller 203 that provides one or more control signals 205 to cause inputs or activations for a vector of inputs 202 (“input vector 202”) to be stored at, or accessed from, a memory location of a first memory 208 (“memory 208”). Likewise, the controller 203 can also provide one or more control signals 205 to cause weights (or parameters) for a matrix structure of weights 204 to be stored at, or accessed from, a memory location of a second memory 210 (“memory 210”). In some implementations, the vector of inputs 202 is obtained from an input tensor, whereas the matrix structure of weights is obtained from a parameter tensor. Each of the input tensor and the parameter tensor may be multi-dimensional data structures, such as a multi-dimensional matrix or tensor. This is described in more detail below with reference to FIG. 9.

Memory 208 and memory 210 are portions of tile memory 108. Each memory location of memory 208, 210 may be identified by a corresponding memory address, such as a logical address that has a corresponding mapping to a physical row of a physical memory bank of the memory. Thus, much like the processor engine 102, a compute tile 106 may also derive a set of contiguous addresses, such as virtual/logical addresses or physical addresses, from a group of requests.

Each of memory 208, 210 can be implemented as a series of physical banks, units, or any other related storage medium or device. Each of memory 208, 210 can include one or more registers, buffers, or both. In some implementations, each bank of the tile memory 108 of a compute tile 106 includes an arbiter that arbitrates access to that bank. For example, access to the bank can be arbitrated in accordance with a bank generation function configured to mitigate against some (or all) of the requests being routed to the same physical memory bank.

In some implementations, memory 208 is an input/activation memory, whereas memory 210 is a parameter memory. In some other implementations, inputs or activations are stored at memory 208, memory 210, or both; and weights are stored at memory 210, memory 208, or both. For example, inputs and weights may be transferred between memory 208 and memory 210 to facilitate certain neural network computations. In some implementations, each of memory 208 and memory 210 may be referred to as tile memory 108.

Each compute tile 106 also includes an input activation bus 211, an output activation bus 215, and a computational unit 212 that includes one or more hardware multiply accumulate circuits (MACs) in each cell 214 a/b/c. Controller 203 can generate control signals 205 to obtain operands stored at the memory of the compute tile 106. For example, controller 203 can generate control signals 205 to obtain: i) an example input vector 202 stored at memory 208 and ii) weights 204 stored at memory 210. Each input obtained from memory 208 is provided to input activation bus 211 for routing (e.g., direct routing) to a compute cell 214 a/b/c in the computational unit 212. Similarly, each weight obtained from memory 210 is routed to a cell 214 a/b/c of the computational unit 212.

As described below, each cell 214 a/b/c performs computations that produce partial sums or accumulated values for generating outputs for a given neural network layer. An activation function may be applied to a set of outputs to generate a set of output activations for the neural network layer. In some implementations, the outputs or output activations are routed for storage and/or transfer via output activation bus 215. For example, a set of output activations can be transferred from a first compute tile 106 to a second, different compute tile 106 for processing at the second compute tile 106 as input activations for a different layer of the neural network.

In general, each compute tile 106 and system 200 can include additional hardware structures to perform computations associated with multi-dimensional data structures such as tensors, matrices and/or data arrays. In some implementations, inputs for an input vector (or tensor) 202 and weights 204 for a parameter tensor can be pre-loaded into memory 208, 210 of the compute tile 106. The inputs and weights are received as sets of data values that arrive at a particular compute tile 106 from a host 220 (e.g., an external host), via a host interface, or from a higher-level control such as controller 225.

Each of compute tile 106 and controller 203 can include one or more processors, processing devices, and various types of memory. In some implementations, processors of compute tile 106 and controller 203 include one or more devices, such as microprocessors or central processing units (CPUs), graphics processing units (GPUs), application specific integrated circuits (ASICs), or a combination of different processors. Each of compute tile 106 and controller 203 can also include other computing and storage resources, such as buffers, registers, control circuitry, etc. These resources cooperate to provide additional processing options for performing one or more of the determinations and calculations described in this specification.

In some implementations, processing unit(s) of controller 203 executes programmed instructions stored in memory to cause controller 203 and compute tile 106 to perform one or more functions described in this specification. The memory of controller 203 can include one or more non-transitory machine-readable storage mediums. The non-transitory machine-readable storage medium can include solid-state memory, a random access memory (RAM), a read-only memory (ROM), an erasable programmable read-only memory (e.g., EPROM, EEPROM, or Flash memory), or any other tangible medium capable of storing information or instructions.

The system 200 receives instructions that define a particular compute operation to be performed by a compute tile 106. The system 200 also receives data such as inputs, activations, weights (or parameters) that are operands for the compute operation. The system 200 can include one or more buses 209 that are used for routing the instructions and data. For example, the system 200 can include a first bus 209-1 that provides instructions, including related commands, opcodes, and operational parameters (not weights), to each of the one or more compute tiles 106 of the system 200. The system 200 can also include a second bus 209-2 that provides data or operands to each of the one or more compute tiles 106 of the system 200.

The buses 209 can be configured to provide one or more inter-connected data communication paths between two or more compute tiles of system 200. For example, the first bus 209-1 can be a ring bus that traverses each compute tile to communicate datasets and a single instruction (or multiple instructions) to one or more compute tiles to execute an ML workload, whereas the second bus 209-2 can be a mesh bus that interconnects two or more tiles to provide data or sets of operands between two or more compute tiles 106.

In some implementations, bus 209-1 and bus 209-2 are distinct data buses. In some other implementations, bus 209-1 and bus 209-2 is the same data bus. In some cases, to process an example workload, a first compute tile 106 arbitrates and executes access requests (e.g., read/write requests) for memory 208, where the requests are based on external data communications that originate from outside the first compute tile 106, such as from a second, different compute tile 106. Such external communications may be received at the first tile 106 via bus 209-2 (e.g., a mesh bus).

Each compute tile 106 is an individual computing unit that cooperates with other tiles 106 in the system 200 to accelerate computations across one or more layers of a multi-layer neural network or across one or more sections of another machine-learning construct. Each compute tile 106 can function as an individual computing unit. For example, each compute tile 106 is a self-contained computational component that is configured to execute a subset of tensor or ML computations independently relative to other compute tiles. In some implementations, compute tiles 106 can also share execution of tensor computations associated with a given instruction.

In some implementations, a host can generate sets of parameters (i.e., weights) and corresponding inputs for processing at a neural network layer. The host can send, via a host interface 220, the parameters to a compute tile 106 for further processing at the tile. In some implementations, the host is processor engine 102 or a respective core or processor of processor engine 102. The controller 203 executes programmed instructions to analyze a data stream associated with the received weights and inputs.

The controller 203 causes inputs and weights of the data stream to be stored at the compute tile 106. For example, the controller 203 can store the inputs and weights/parameters in the local tile memory 108 of the compute tile 106. The controller 203 can also analyze the input data stream to detect an operation code (“opcode”). The system 200 can support various types of opcodes, such as opcode types that indicate operations for vector-matrix multiplication and/or elementwise vector operation.

Based on one or more opcodes, the controller 203 can activate or execute a bank generation function to arbitrate requests for access to tile memory 108 of a compute tile 106. For example, the controller 203 leverages the bank generation function to arbitrate two or more requests such that each of the two or more requests are processed against different physical banks of the tile memory. The controller 203 can employ a predetermined bank selection scheme that is programmed or encoded at the controller 203 before inference determinations are performed at the compute tile 106.

In some implementations, a given compute operation involves multiple requesters that each require access to resources of the memory 208. For example, a computational workload performed at compute tile 106 can trigger memory access requests due to tensor traversal operations that require read and write access to respective address locations of memory 208. The system 200 can use byte-level addressing functions of an example instruction set architecture (ISA) to process these requests to access one or more bytes of data stored at address locations of memory 208, 210. As described below, these address locations can correspond to elements of an input (or parameter/weight) tensor that is processed to execute a machine-learning workload.

In addition to the tensor read/write operations, processing the workload can also involve processing read or write access requests to: i) move data (e.g., parameters) from memory 208 (narrow memory) to memory 210 (wide) and ii) move data from memory 210 (wide) to memory 208 (narrow). Tensor operations (TensorOps) can be indicated by an opcode in an instruction (e.g., a single instruction) received at a compute tile 106. For example, a “ByteAddressingMode” instruction can include one or more opcodes for a tensor operation that is executed at the compute tile 106 to traverse respective elements of an input tensor. In general, tensor operations can be performed to: i) consume (or read) tensors from memory 208, 210 and ii) produce (or write) tensors to memory 208, 210.

As used in this document, “narrow” may refer to one or more memory units that each operate on, and store, data having a size (or width) that is equal to or less than 16-bits, whereas “wide” may refer to one or more memory units that each operate on, and store, data having a size (or width) that is equal to or less than 64-bits. For example, a size or width for narrow memory 208 can between 8-bits and 16-bits, whereas a size or width for wide memory 210 can between 32-bits and 64-bits. Of course, other sizes and data widths that exceed these example ranges are also contemplated for memory 208, 210.

FIG. 3 shows an example architecture 300 for a portion of a tensor mapping unit 104 in a compute tile 106. In particular, the architecture 300 is an example architecture for a second tensor module 104-n that is located in each of the compute tiles 106. The architecture 300 includes an input buffer 302 for storing one or more requests that are routed to a particular tensor module 104-n and an optional disassemble logic 304 for processing and/or parsing constituent parts of an example request. The tensor mapping unit 104 is configured to receive requests that can include up to 32 bytes. A request may also include more than 32 bytes based on design preference.

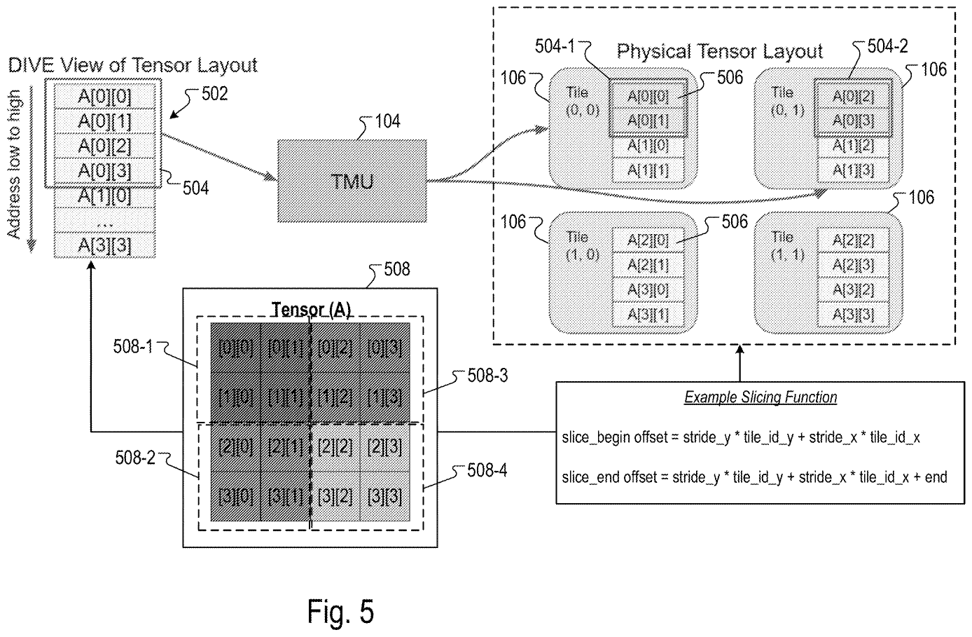

In some implementations, the respective data for each of these requests (e.g., 32B bytes) is mapped to one or more tile memory instances. A tile memory instance can refer to the narrow memory 208 of a compute tile 106. The aspects of how tensor data is mapped for a particular tile memory instance is established or defined based on a slicing function. An example slicing function and its application to a tensor is described below with reference to FIG. 5. In some implementations, the disassemble logic 304 includes a slicing function that is used to disassemble or parse bytes of a 32B request in accordance with one or more tile memory instances. For example, at each compute tile 106, a respective second tensor module 104-n of the tensor mapping unit 104 can disassemble a request (e.g., a request with 32 or fewer bytes) received at the input into several smaller sub-requests based on the disassemble logic 304.

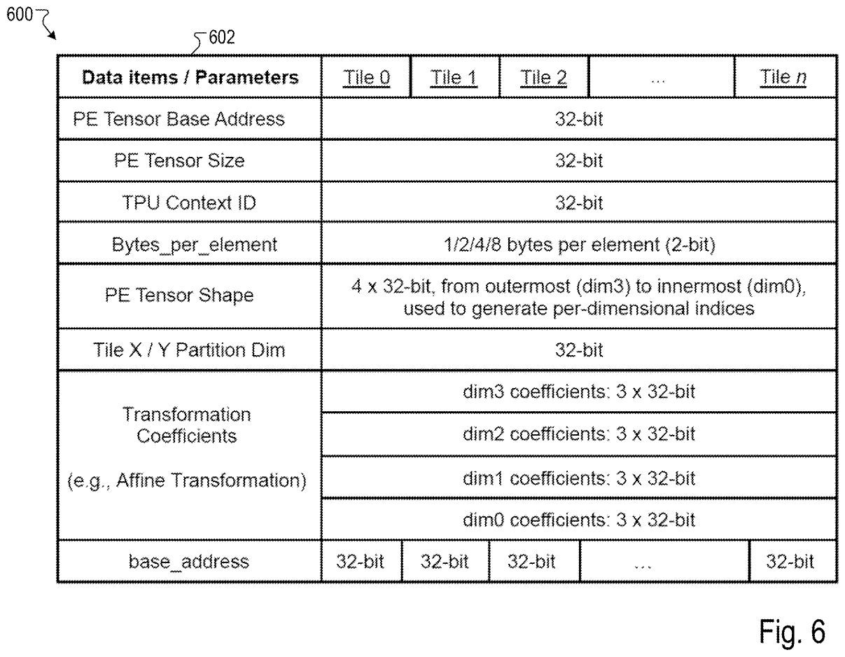

The architecture 300 also includes access logic 306 for performing one or more lookups or access operations against memory locations of tile memory 108. In some implementations, the access logic 306 is configured to perform two or more sequential lookups against memory locations of tile memory 108. The sequential lookups can be based on a nested loop or loop nest. The memory locations correspond to elements of a tensor and the access logic 306 can run multiple access iterations to access the memory locations. Each iteration is used to access one or more tensor elements, where each element (or tensor element) corresponds to a positional element (x, y) along one or more dimensions of a tensor. In general, the access logic 306 can be based on a tensor mapping algorithm, which is described below with reference to FIG. 6.

The architecture 300 includes mask generation logic 308 for generating a mask field that is applied to data along a response path for a tensor module 104-n or compute tile 106 that includes the tensor module 104-n. For example, when a tensor module 104-n receives a request, the logic and compute elements of architecture 300 are used to generate data representing a response to the request. This data is conveyed using an example data structure, such as a 32B data structure. The data structure can include more than 32 bytes (e.g., 48B or 64B) or fewer than 32 bytes (e.g., 16B or 8B) depending on design preference.

Each tensor module 104-n is configured to receive and process at least a read request and a write request. Using its architecture 300, for a read request, the tensor module 104-n causes a 32-bit mask field to be generated from its respective compute tile 106. For an example 32B response to the request, this mask field indicates which bytes among the 32 bytes of data are valid in the response.

In some implementations, interface block 110 is configured to detect that a response to a particular request has arrived and read (or scan) a mask field in that response to perform any required shifting or positioning operations. For example, the interface block 110 can scan a response, detect the mask field, shift the response data to the appropriate position, and merge the response data with corresponding data from one or more previously received responses. The interface block 110 can perform any required parsing operations in support of scanning or detecting the mask field and shifting the response data.

Tensor mapping unit 104 is configured to issue a write to the tile memory 108 when a corresponding strobe in the request bit is set. For example, each write request has a strobe field which indicates byte offsets to write. The tensor module 104-n is configured to generate a write response for its compute tile 106 to indicate how many bytes have been written to the corresponding tile memory 108 of its compute tile 106. Additionally, this write operation can involve at least two parameters: i) num_bytes_written and ii) request_size. When the num_bytes_written==request_size, this indicates that the write operation is complete and a write response can be generated and sent back to the processor engine 102.

As indicated above, the size of an input request that is provided to a second tensor module 104-n of the tensor mapping unit 104 may be bounded by some maximum number of bytes, such as 32 bytes, 16 bytes, or 64 bytes. Given that the size of the input requests to the tensor mapping unit 104 is bounded by a parameter, max_input_bytes, then the number of smaller sub-requests that may be generated by the disassemble logic 304 is bounded by the expression: max_input_bytes/bytes_per_element, where “bytes_per_element” defines the size data (in bytes) for a given element of a tensor.

The tensor mapping unit 104 includes merging logic 310 that can optionally incorporate an output buffer that stores responses for each sub-request. In some cases, the merging logic 310, and any associated buffers, is implemented as a state machine that is configured to track each of the sub-requests. The merging logic 310 (or state machine) can track each sub-response against a corresponding sub-request and store each sub-response in an output buffer. For example, leveraging the merging logic 310, given a 32B request the tensor mapping unit 104 can send a response back to the ring bus 109 (e.g., the fabric interface) only after sub-responses from all the sub-requests are received and merged.

FIG. 4 is a block diagram that shows aspects of a memory mapping process 400 (“process 400”). The process 400 represents a memory mapping operation for translating a set of logical (e.g., virtual) addresses maintained by the processor engine 102 to a set of physical addresses maintained by one or more compute tiles 106.

The system 100 uses the tensor mapping unit 104 to execute process 400. More specifically, the tensor mapping unit 104 is configured to determine a mapping of a first set of addresses of a virtual address space 402 to a second, different set of addresses of a physical address space 404. The virtual address space 402 can be a continuous virtual address view of a given tensor, whereas the physical address space 404 is a physical mapping of addresses that is distributed across two or more compute tiles 106.

The processor engine 102 can include a system port memory region 406. In some implementations, the processor engine 102 accesses the tile memory 108 by dispatching requests via the system port and routing those requests based on the AXI protocol. The tensor mapping unit 104 can pick up and handle requests (e.g., AXI requests) at the system port boundary without having visibility to the source of these requests (e.g., LD/ST instructions).

The system port memory region 406 is used to expose programs executed at the processor engine 102 to the physical address space 404 of the compute tiles 106. The virtual address space 402 can include a set of contiguous virtual addresses derived for a logical memory accessed by programs of the processor engine 102. In general, the logical memory and virtual addresses can correspond to the respective physical aspects of each tile memory 108 of a particular compute tile 106.

The logical memory, ports of the logical memory, and any associated arbiters can be implemented in software, hardware, or both. In some implementations, the logical memory and its ports as well as the arbiters are controlled based on control signals generated by a controller of the processor engine 102. The logical memory can have multiple logical ports and each port can be connected to, or associated with, a different requestor that requests to access physical resources of tile memory 108. In some implementations, a requestor is the processor engine 102, a processor or core of the processor engine 102, or a program being executed at the processor engine 102.

To process a given access request (e.g., for each port), the tensor mapping unit 104 determines the compute tiles to which the request will be routed based at least on one or more addresses in that request. For example, based on one or more instructions, the tensor mapping unit 104 generates multiple tensor element positions for a given tensor and then determines an assignment or mapping of subsets of the multiple tensor element positions to the compute tiles 106. The tensor mapping unit 104 can then analyze addresses of a request against mapping or assignment information for the tensor element positions. The tensor mapping unit 104 can determine a tile memory 108 to which the request will be routed based on the analysis.

FIG. 5 shows examples of a virtual tensor layout and a physical tensor layout. In some implementations, a program executed at the processor engine 102 can access the virtual address space 402. The virtual address space 402 can include a grouping of linearized addresses that represent a tensor layout 502.

The tensor mapping unit 104 can map a virtual tensor layout 502 associated with a virtual address space to physical addresses of memory banks in tile memory 108 of a given compute tile 106. More specifically, the tensor mapping unit 104 is configured to perform a mapping between linearized addresses for a tensor layout 502 in a program's virtual address space to physical addresses of the tile memory 108. The tensor layout 502 can include multiple tensor element positions 504 for an example tensor, such as Tensor (A) which is described below.

The system 100 can use its tensor mapping unit 104 to determine one or more subsets 504-1, 504-2, for a given set of tensor element positions. In some implementations, the system 100 determines one or more subsets 504-1, 504-2 based on compute logic for a bypass mode, which is also described below. Each subset 504-1, 504-2 can include one or more tensor element positions 504, where each tensor element position corresponds to a per-dimension logical offset 506. Each logical offset 506 can be generated as an output of a tensor mapping algorithm implemented at the tensor mapping unit 104.

The tensor mapping unit 104 enables a program instance/context executing at the processor engine 102 to view a tensor(s) as if the tensor is laid out in a continuous region of memory. This advantageous and expanded view of the tensor reduces overall program complexity at system 100. For example, from a program point of view, tensors (or tensor data) stored in the tile memory 108 are exposed to the program in a logical layout such that a program instantiation at the processor engine 102 can access the tensor as if the tensor was stored in main memory.

An example of this is illustrated at FIG. 4 using the virtual address space 402 and at FIG. 5 using the tensor layout 502. In other words, a program executed at the processor engine 102 can view a tensor as if it is stored in a contiguous memory region. But in actuality, the tensor may be partitioned into multiple slices across different dimensions and stored in, and across, multiple tile memory locations. For example, an integrated circuit can include a grid of four compute tiles 106, that are identified as: tile (0, 0); tile (0, 1); tile (1, 0); and tile (1, 1).

An example tensor 508, Tensor (A), can be partitioned (or sliced) based on a slicing function. The slicing function specifies how a tensor is sliced across tile memory instances. More specifically, the slicing function specifies the range of the tensor data that is stored in each tile memory instance. For a multi-dimensional tensor, the slicing function can specify a range of tensor data in each dimension when the tensor has multiple dimensions. The range can be specified based on a starting (or begin) element position [x,y] and an end element position [x,y], where each element position represents a position of a tensor element along a given dimension of the tensor.

As an example, tensor 508, Tensor (A), is a two-dimensional 4×4 tensor (T[4][4]), where each dimension has four elements. Tensor (A) can be sliced into a 2×2 set of compute tiles 106 using the following slicing function: slice_begin=stride_y*tile_id_y+stride_x*tile_id_x and slice_end=slice_begin+end, where stride_y=2; stride_x=2; end=1. tile_id_y and tile_id_x are the coordinates of the compute tiles. The following table indicates the dimensions and ranges of tensor data that are written to the 2×2 set of compute tiles 106, in accordance with the slicing function.

TABLE 1
Ranges of Tensor Data for Tensor (A)

| Tile ID | Slice_begin | Slice_end |
|---|---|---|
| Tile[0][0]: | slice_begin[0][0]; | slice_end[1][1] |
| Tile[0][1]: | slice_begin[0][2] | slice_end[1][3] |
| Tile[1][0]: | slice_begin[2][0]; | slice_end[3][1] |
| Tile[1][1]: | slice_begin[2][2]; | slice_end[3][3] |

In the example of FIG. 5, Tensor (A) is partitioned (or sliced) such that a first partition 508-1 is stored at tile (0, 0), a second partition 508-2 is stored at tile (0, 1), a third partition 508-3 is stored at tile (1, 0), and a fourth partition 508-4 is stored at tile (1, 1). As indicated above, this capability of partitioning/slicing, distribution, and storage of tensor dimensions across the compute tiles 106 and locations of tile memory 108 is enabled, in part, by the dedicated portions of compute logic and/or hardware circuitry for tensor mapping unit 104 located inside each compute tile 106.

FIG. 6 shows an example tensor mapping table 600. The tensor mapping table 600 includes multiple data items 602 (e.g., parameters) corresponding to an example tensor mapping algorithm. For example, the tensor mapping table 600, including one or more of the respective values for the parameters of the table, can be generated based on an example tensor mapping algorithm. The tensor mapping algorithm is implemented or executed at system 100 using the tensor mapping unit 104.

The tensor mapping algorithm can be executed to perform address remapping from a linearized set of virtual/logic addresses of the processor engine 102 to the physical addresses of a respective tile memory 108 across one or more compute tiles 106. The tensor mapping unit 104 is configured to store tensor mapping information in a data structure that represents the tensor mapping table 600. In some implementations, the tensor mapping unit 104 stores multiple instances of a tensor mapping table 600, where one or more instances of the multiple instances are stored across each of the second tensor modules 104-n.

For example, a first tensor mapping table 600 can be stored in a tensor module 104-0 of a first compute tile 106-0, whereas a second, different tensor mapping table 600 can be stored in a tensor module 104-1 of a second, different compute tile 106-1. In some implementations, a tensor mapping table 600 is stored at a tensor module 104-n using a series of CSRs 230. In some other implementations, a tensor mapping table 600, including various data/parameter values associated with the table, are stored in a tensor module 104-n using one or more example memory devices, such as a register 230, a buffer, a program counter, etc. The tensor mapping table 600 can also be stored using a combination of such devices.

In general, the system 100 uses the tensor module 104-n to process one or more tensors based on requests or instructions from a program instance. For each incoming request, the tensor mapping unit 104 is configured to traverse one or more valid instances of its tensor mapping tables 600. For example, when processing a given tensor, the tensor mapping unit 104 can generate control signals to trigger traversal operations against a respective tensor mapping table 600 stored at some (or all) of the compute tiles 106. More specifically, based on instructions or an incoming request, control signals are generated to cause a particular tensor module 104-n to traverse various portions of data/parameters 602 for a tensor mapping table 600 stored at the tensor module 104-n.

The tensor module 104-n traverses its tensor mapping table 600 to identify and/or determine whether its table 600 includes mapping information that is relevant to the incoming request. In some implementations, a portion of the information for a tensor mapping table 600 is duplicated across the compute tiles 106 such that each tensor mapping table 600 stored at a respective compute tile 106 includes the same portion of information. For example, values for a substantial portion of the information or data/parameters 602 can be duplicated across the compute tiles 106, such that each compute tile 106 has the same CSR values.

This duplication translates to a programming efficiency. For example, rather than programming values for each compute tile 106 (e.g., programming kNumTiles times), the system 100 can program these register values once and broadcast the values to the compute tiles 106. In some implementations, the interface fabric includes a register/CSR broadcast bus. The system 100 uses this CSR broadcast bus to broadcast the tensor mapping table values that are duplicated across the compute tiles 106. One or more data items and/or parameters of the tensor mapping table 600 can be programmed by control logic (e.g., a system controller) of the system 100, the processor engine 102, or both. For example, the “TPU Context ID” information can be programmed by the control logic, whereas other information or parameters can be programmed by the processor engine 102.

As mentioned above, a tensor mapping table 600, including one or more of its respective parameter values, can be generated based on a tensor mapping algorithm. The tensor mapping algorithm can include one or more steps. A request for tensor data includes addresses that are translated to tile memory physical addresses based on the one or more steps of the tensor mapping algorithm. In some implementations, the tensor mapping algorithm includes: i) a first step where a linearized set of virtual/logical addresses are converted from the processor engine 102 virtual address space to per-dimension logical offsets; and ii) a second step where the per-dimension logical offsets are convert to tile memory physical addresses.

Example pseudo code for the first translation step of the tensor mapping algorithm is shown below.

```
// convert linearized address from DIVE to per-dimension logical offsets.
for each TPUContextID:
  if (IncomingTpuContextId != TPUContextID) continue;
  for each TensorMappingTable:
    if (IncomingAddress >= TensorMappingTable.base_address &&
      IncomingAddress < TensorMappingTable.base_address +
      TensorMappingTable.tensor_size) {
      offset = IncomingAddress −
      TensorMappingTable.base_address;
      dim0_offset = offset % dive_tensor_shape.dim0
      dim1_offset = offset / dive_tensor_shape.dim0 %
      dive_tensor_shape.dim1
      dim2_offset = offset / (dive_tensor_shape.dim0 *
      dive_tensor_shape.dim1) % dive_tensor_shape.dim2
      dim3_offset = ...
    }
  }
}
```

Based on the result of the first translation step, the tensor mapping unit 104 can determine whether a corresponding tile memory 108 includes data for the request. This determination can include a scan or probe performed by a particular tensor module 104-n of the tensor mapping unit 104. This scan or probe can be performed to detect if there is any overlap between an access range of an incoming request and a slice range in the corresponding tile memory 108 of the compute tile 106 that includes the particular tensor module 104-n.

If the particular tile memory 108 does not include data relevant to the request, the system 100 can generate an early response, e.g., indicating no data for the request. In some implementations, the system 100 generates the early response and terminates the tensor mapping algorithm, thereby avoiding operations for the second translation step. The early response and corresponding termination translates to computational savings and efficiency by avoiding the needless processor cycles and resource overhead for the second translation step.

To simplify the hardware implementation, the tensor mapping unit 104 can perform a rounding to the access range of the request such that the access range is a hyper-rectangle. A hyper-rectangle is a generalized rectangle in d-dimensions (higher dimensions). For example, an access range of five elements can be rounded up to eight elements to form a rectangle. This rounding operation can be performed before performing an overlapping check between the access range and a slice range.

In some implementations, the slice_range is set (e.g., consistently set) as a hyper-rectangle. Thus, in these implementations, the overlap check involves determining whether two hyper-rectangles overlap. This check can be performed using a set of comparators that are configured based on any known algorithm for finding overlapping lengths along each corresponding dimension of the hyper-rectangles. In some implementations, the check can be performed to evaluate functional correctness of the hardware.

If the tensor mapping unit 104 determines that the tile memory 108 of the compute tile 106 should service the request, the tensor mapping unit 104 causes the tensor mapping algorithm to proceed to the second translation step. Example pseudo code for the second translation step of the tensor mapping algorithm is shown below.

```
# The ordering of dimensions between logic (PE's view) and physical (Tile's view) is the same,
# it guarantees that the nested loop can be terminated after size iterations, where size
is provided
# through the AR channel's ARSIZE field.
count = 0
slice_range = ... // derive the range of the slice using affine coefficients
slice_shape = ... // derive the shape of the slice using affine coefficients
for dim2_offset = i; dim2_offset < dim2_dim; i++:
  for dim1_offset = j if first_iteration else 0; dim1_offset < dim1_dim; j++:
    for dim0_offset = k if first_iteration else 0; dim0_offset < dim0_dim; k++:
      if (dim2_offset, dim1_offset, dim0_offset) in slice_range:
        tile_mem_addr = flatten_addr((dim2_offset, dim1_offset, dim0_offset),
        slice_shape)
        mask |= (1 << count)
      count++;
      if (count == size): return
```

The preceding pseudo code for the second translation step uses a reading from a rank-3 tensor as an example. In some implementations, to reduce hardware costs, the system 100 can enforce one or more assumptions on aspects of the tensor slicing in the tile memory 108. Under the assumptions, the address translation operations associated with the second translation step are performed using a nested loop. The assumptions can include configuring an example slicing function to be thread oblivious and causing an ordering of dimensions to be the same between the logical address space (PE's view) and the physical address space (compute tile's view). Configuring the slicing function to be thread oblivious reduces the hardware cost by having a single base_address CSR per compute tile 106 in the tensor mapping table 600.

In some implementations, the slicing function is based on a transformation operation performed on an input sample, for example, as a pre-processing step that precedes an inference computation. For example, the slicing function can be based on an affine transformation that is used to determine a mapping of a tensor to the compute tiles 106. The tensor mapping unit 104 can determine an allocation of different subsets of tensor element positions to one or more of the compute tiles 106 in accordance with a slicing function that is based on the affine transformation.

A respective tensor mapping algorithm can be executed in each of the compute tiles 106. In some implementations, the tensor mapping algorithm is executed at each compute tile concurrently. At each compute tile 106, a tensor mapping algorithm is executed to read the tile memory 108 of that tile and to generate (and/or populate) the mask that indicates which bytes are read from a particular slice of tensor elements that are assigned or mapped to that compute tile 106.

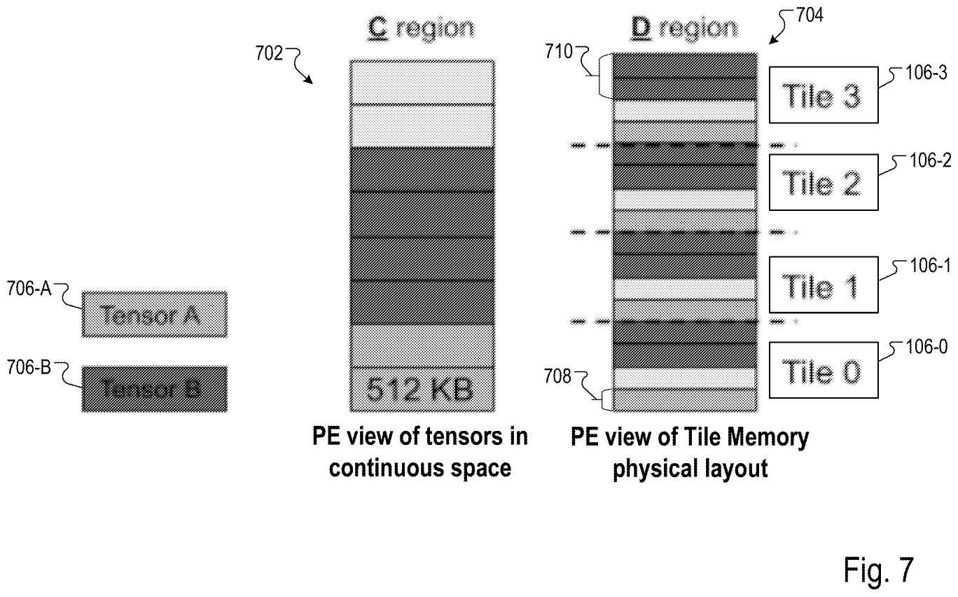

FIG. 7 shows examples of memory regions and a distribution of tensor data in those memory regions. In some implementations, system 100 includes a bypass mode, where the processor engine 102 can be configured to access the tile memory 108 without going through (or directly using) the tensor mapping unit 104.

Example scenarios that use the bypass mode can include, but are not limited to: i) a number of tensors that are shared between the processor engine 102 and the compute tiles 106 is greater than a number of hardware provisioned tensor mapping tables and ii) processing and resource overheads for programming CSRs 230 in a tensor module 104-n outweighs the associated software translation overheads, which can happen when the data to be accessed is very small (e.g., less than 64 data elements or between 64 and 128 data elements).

The functions and capability of the bypass mode are based in part on a dual region mapping configuration at system 100. The dual region mapping enables bypass mode functions such that one or more tensors can be accessed while bypassing the tensor mapping unit 104, whereas one or more other tensors can be accessed through (e.g., using) the tensor mapping unit 104. For the dual region mapping, the system 100 can include (or determine) a mapping of the tile memory 108 in the address space of the processor engine 102. For example, the system 100 can map tile memory 108 across two regions in the address space of the processor engine 102.

As shown in the example of FIG. 7, the two regions include a Continuous region 702 (“C region 702”) and a Distributed region 704 (“D region 704”). Each of regions 702, 704 can have a size (in bytes) that is kNarrowMemoryCapacity*kNumTiles bytes. In some implementations, for a given number of tile (kNumTiles), the size may also be based on, or include, kWideMemoryCapacity. Referring again to the dual region mapping, the system 100 can map tile memory 108 across C region 702 and D region 704 in the address space of the processor engine 102. This address space of the processor engine 102 can include, or correspond to, the virtual address space 402 described above.

The C region 702 can be configured to provide a continuous virtual address view of a given tensor, such that the processor engine 102 sees tensors (or tensor data) that is stored in the C region as being continuous laid out in memory. Thus, the addresses in C region 702 cannot be used to access tile memory 108 directly. When tensors in the C region 702 are mapped using the tensor mapping unit 104, the processor engine 102 can generate requests and convey, via the requests, the addresses of this C region 702 directly via the system port 406.

In some implementations, the fabric interface detects such requests and triggers a translation operation at the tensor mapping unit 104. For example, the interface block 110 and the first and second tensor modules of the tensor mapping unit 104 cooperate to detect such requests and trigger a translation operation using respective portions of mapping information stored in tensor mapping tables of tensor modules 104-n.

The D region 704 is configured to provide a direct mapping of the physical address space of tile memory 108 to the memory/address space of the processor engine 102. For example, an integrated circuit can include one or more clusters of compute tiles 106 and each cluster can include at least four tiles, Tile 0-Tile 3. The D region 704 can provide a direct mapping of the physical address space for a respective tile memory 108 at each of compute tiles 106-0, 106-1, 106-2, and 106-3.

In some implementations, addresses that fall within the D region 704 do not go through the tensor mapping unit 104. Rather, the processor engine 102 can include an example bus interface that couples the processor engine 102 to the bus 109 and/or the fabric interface. The processor engine 102 can generate a request that is routed to the bus interface for sending out over the tile memory fabric. The request can be an incoming request that includes one or more addresses. The system 100 can generate a command packet for the incoming request and the bus interface can populate a bypass field in the command packet based on the region (e.g., D region 704) the incoming request falls into.

A tensor for a particular program instance (e.g., an inference workload) can be mapped into C region 702. In some cases, requests for data associated with that tensor may implicate mapping information that does not exist at the tensor mapping unit 104. The system 100 can be configured to generate an error (e.g., error flag) if the fabric interface receives a request that falls into the C region 702, but the tensor mapping unit 104 does not include any relevant mapping information specific to that request.

In particular, when the mapping of that tensor did not go through the tensor mapping unit 104, the program instance of the processor engine 102 can trigger or perform a software-based translation of addressing information associated with that tensor. The software-based translation converts addresses in the C region 702 to addresses in the D region 704 before sending the addressing information to the system port 406. As indicated above, addresses in the D region 704 represent physical addresses of tile memory 108.

The system 100 can use the two/dual region mapping to map the same tile memory 108 to avoid address aliasing. For example, two tensors (both uint8) can be stored in a four tile configuration that includes compute tiles 106-0, 106-1, 106-2, and 106-3. The four compute tiles 106 can include 4 MB total memory space. A first tensor 702-A, “Tensor A,” can include one million (“1M”) elements, whereas a second, different tensor 702-B, “Tensor B,” can include two million (“2M”) elements.

The data for the 1M elements of tensor 702-A can be distributed to, and stored at, the first 256 KB of memory 708 in each tile memory 108 across the four tiles. Relatedly, the data for the 2M elements of tensor 702-B can be distributed to, and stored at, the last 512 KB of memory 710 in each tile memory 108 across the four tiles. The example of FIG. 7 illustrates the respective memory layout of each memory region 702, 704. As the example implies, the system 100 cannot represent both Tensor A and Tensor B using one memory region without aliasing. Therefore, the system 100 is operable to use the two/dual region to map the same tile memory 108 unto a virtual address space to avoid address aliasing.

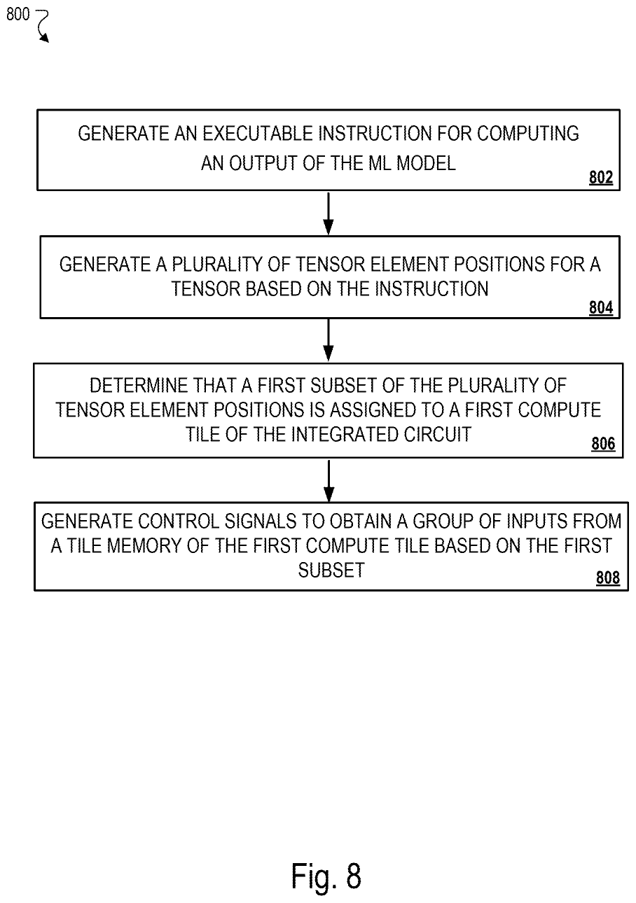

FIG. 8 is an example process 800 for a tensor mapping operation performed using tensor mapping unit 104 described above. In general, process 800 can be implemented or executed using the systems 100, 200 described above. Hence, descriptions of process 800 may reference the above-mentioned computing resources of systems 100, 200. In some examples, the steps or actions of process 800 are enabled by programmed firmware instructions, software instructions, or both. Each type of instruction may be stored in a non-transitory machine-readable storage device and is executable by one or more of the processors or other resources described in this document, such as a compute tile of a hardware accelerator or neural network processor.

In some implementations, the steps of process 800 are performed at a hardware integrated circuit to generate a machine-learning (ML) output, including an output for a neural network layer of a neural network that implements the ML model. For example, the output can be a portion of a computation for a ML task or inference workload to generate an image processing or image recognition output. As indicated above, the integrated circuit can be a special-purpose neural network processor or hardware ML accelerator configured to accelerate computations for generating different types of data processing outputs.

Referring again to process 800, system 100 generates an executable instruction for computing an output of the ML model (802). As indicated above, the ML model is implemented at an integrated circuit configured to accelerate tensor computations for the ML task or inference workload. The instruction can be generated by a processor engine 102 and routed to a tensor mapping unit 104. For example, the instruction is routed to a first tensor module of the tensor mapping unit 104.

System 100 generates multiple tensor element positions for a tensor based on the instruction (804). The first tensor module processes and/or executes the instruction to generate the multiple tensor element positions corresponding to a tensor such as an input tensor that is processed by the ML model to generate the model output. The input tensor can correspond to an input image that is processed by the ML model. In some implementations, the tensor mapping unit 104 generates the tensor element positions by performing an affine transformation on the input image based on the instruction received from the processor engine 102.

System 100 determine that a first subset of the tensor element positions is assigned to a first compute tile of the integrated circuit (806). For example, the tensor mapping unit 104 generates a tensor mapping table 600 that includes mapping information specific to: i) the tensor element positions; ii) the subsets of the tensor element positions; and iii) an assignment of the subsets to the compute tiles 106. In some implementations, the tensor mapping unit 104 can determine that the first subset is assigned to the first compute tile based on the tensor slicing and/or tensor element allocations of the tensor mapping table 600.

For example, the tensor mapping unit 104 can determine an allocation of different subsets of tensor element positions to the one or more of the compute tiles 106 in accordance with information in the tensor mapping table 600. In some implementations, the allocations and slicing of an example tensor is based on a slicing function, where the slicing function is based on a particular transformation operation applied to an input sample. In some examples the transformation operation is an affine transformation performed on an input image (e.g., the input sample).

The system 100 generates control signals to obtain a group of inputs from a tile memory of the first compute tile based on the first subset (808). More specifically, the tensor mapping unit 104 comprises multiple second tensor modules 104-n that generate control signals that are used/processed at a compute tile 106 and/or a tile memory 108 to obtain data corresponding to the first subset of the tensor element positions. For example, each tensor module 104-n of the tensor mapping unit 104 can include a set of tensor mapping register (e.g., CSRs). Each tensor module 104-n can be configured to generate control signals for programming and address translation operations at the compute tile 106 that includes the tensor module 104-n.

In some implementations, each tensor module 104-n at a compute tile 106 is configured to process a predefined number of multi-dimensional tensors and the tensor module 104-n can include a set of CSRs per tensor. Control signals can be generated to program values of the CSRs and to translate tensor indices in a tensor mapping table 600 of the tensor module 104-n to corresponding memory address locations. For example, the tensor indices are represented by tensor element positions, where each element position can correspond to an input (e.g., pixels of an image) in the group of inputs.

In some implementations, the affine transformation is performed to pre-process an image for an image recognition task of a machine-learning workload. For example, the pre-processing task may be performed to resize or crop the image before processing an inference task against the image to recognize one or more objects in the image. Thus, the tensor offsets or tensor element positions can be generated based on a slicing function that defines how the tensor elements and/or dimensions will be sliced for allocation and mapping to tile memory 108 to perform the affine transformation.

FIG. 9 illustrates examples of tensors or multi-dimensional matrices 900 that include an input tensor 904, variations of a parameter tensor 906, and an output tensor 908. In the example of FIG. 9, each of the tensors 900 include respective elements, where each element can correspond to a respective data value (or operand) for computations performed at a given layer of a neural network.

For example, each input of input tensor 904 can correspond to a respective element along a given dimension of input tensor 904, each weight of parameter tensor 906 can correspond to a respective element along a given dimension of the parameter tensor 906, and each output value or activation in a set of outputs can correspond to a respective element along a given dimension of output tensor 908. Relatedly, each element can correspond to a respective memory location or address in a memory of a compute tile 106 that is assigned to operate on one or more dimensions of a given tensor 904, 906, 908.

The computations performed at a given neural network layer can include multiplication of an input/activation tensor 904 with a parameter/weight tensor 906 on one or more processor clock cycles to produce layer outputs, which may include output activations. Multiplying an activation tensor 904 with a weight tensor 906 includes multiplying an activation from an element of tensor 904 with a weight from an element of tensor 906 to produce one or more partial sums. The example tensors 906 of FIG. 9 can be unmodified parameter tensors, modified parameter tensors, or combination of these. In some implementations, each parameter tensor 906 corresponds to a modified parameter tensor that includes non-zero compressed sparse parameter values that are derived based on a sparsity exploitation technique that exploits sparsity (e.g., zero values) in parameter tensors.

The processor cores of system 100 can operate on: i) scalars that correspond to a discrete element in some multi-dimensional tensor 904, 906; ii) a vector of values (e.g., input vector 102) that include multiple discrete elements 907 along the same or different dimensions of some multi-dimensional tensor 904, 906; or iii) a combination of these. The discrete element 907, or each of the multiple discrete elements 907, in some multi-dimensional tensor can be represented using X,Y coordinates (2D) or using X,Y,Z coordinates (3D) depending on the dimensionality of the tensor.

The system 100 can compute multiple partial sums that correspond to products generated from multiplying a batch inputs with corresponding weight values. As noted above, the system 100 can perform an accumulation of products (e.g., partial sums) over many clock cycles. For example, the accumulation of products can be performed in a random access memory, shared memory, or scratchpad memory of one or more compute tiles based on the techniques described in this document. In some implementations, an input-weight multiplication may be written as a sum-of-product of each weight element multiplied with discrete inputs of an input vector 102, such as a row or slice of the input tensor 904. This row or slice can represent a given dimension, such as a first dimension 910 of the input tensor 904 or a second, different dimension 915 of the input tensor 904.

In some implementations, an example set of computations can be used to compute an output for a convolutional neural network layer. The computations for the CNN layer can involve performing a 2D spatial convolution between a 3D input tensor 904 and at least one 3D filter (weight tensor 906). For example, convolving one 3D filter 906 over the 3D input tensor 904 can produce a 2D spatial plane 920 or 925. The computations can involve computing sums of dot products for a particular dimension of an input volume that includes the input vector 102.

For example, the spatial plane 920 can include output values for sums of products computed from inputs along dimension 910, whereas the spatial plane 925 can include output values for sums of products computed from inputs along dimension 915. The computations to generate the sums of the products for the output values in each of spatial planes 920 and 925 can be performed: i) at the compute cells 214 a/b/c, ii) directly at the memory 210 using an arithmetic operator coupled to a shared bank of the memory 210, iii) or both. In some implementations, reduction operations may be streamlined and performed directly at a memory cell (or location) of memory 210 using various techniques for reduction of accumulated values.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. An integrated circuit configured to accelerate tensor computations for a machine-learning model implemented at the integrated circuit, the integrated circuit comprising:
a processing engine; and
a tensor mapping unit configured to:
generate a plurality of tensor element positions for a tensor based on an instruction received from the processing engine;
determine that a first subset of the plurality of tensor element positions is assigned to a first compute tile of the integrated circuit; and
generate control signals to obtain a group of inputs from a tile memory of the first compute tile based on the first subset.

2. The integrated circuit of claim 1, wherein the tensor mapping unit is configured to generate the plurality of tensor element positions by performing an affine transformation on an input image based on the instruction received from the processing engine.

3. The integrated circuit of claim 1, wherein the integrated circuit comprises a plurality of compute tiles and the tensor mapping unit is further configured to:
determine an allocation of different subsets of the plurality of tensor element positions to one or more of the plurality of compute tiles.

4. The integrated circuit of claim 3, wherein the tensor mapping unit comprises a first tensor module that:
generates the plurality of tensor element positions; and
generates, based on one or more instructions from the processing engine, a plurality of tensor element positions for each of a plurality of tensors.

5. The integrated circuit of claim 4, wherein:
the tensor mapping unit comprises a plurality of second tensor modules that generate control signals for obtaining data corresponding to the plurality of tensor element positions; and
the plurality of tensors are processed at the integrated circuit using each second tensor module and each of the plurality of compute tiles.

6. The integrated circuit of claim 5, wherein the tensor mapping unit is configured to generate a tensor mapping table that includes mapping information specific to:
i) the plurality of tensor element positions;
ii) multiple subsets of the plurality of tensor element positions; and
iii) an assignment of the first subset to the first compute tile.

7. The integrated circuit of claim 5, wherein the tensor mapping unit is configured to determine a mapping of a first set of addresses of a virtual address space to a second, different set of addresses of a physical address space.

8. The integrated circuit of claim 5, wherein the first tensor module is coupled to the processing engine and is external to each of the plurality of compute tiles.

9. The integrated circuit of claim 8, wherein a second tensor module of the plurality of second tensor modules is located at each compute tile of the plurality of compute tiles included at the integrated circuit.

10. The integrated circuit of claim 9, wherein:
each second tensor module is configured to access a tile memory of the compute tile that includes that second tensor module; and
that second tensor module accesses the tile memory based on a particular subset of the plurality of tensor element positions that is assigned to that compute tile.

11. The integrated circuit of claim 1, wherein:
each input in the group of inputs corresponds to a respective tensor element position in the first subset; and
each element of the tensor corresponds to an input and an address location in a tile memory that stores the input.

12. The integrated circuit of claim 1, wherein:
the plurality of tensor element positions correspond to different dimensions of two or more multi-dimensional tensors; and
at least one of the multi-dimensional tensors is an input tensor or a parameter tensor that is processed at the integrated circuit using the processing engine, the tensor mapping unit, and one or more compute tiles.

13. A method for accelerating tensor computations for a machine-learning (ML) model implemented on an integrated circuit that includes a processing engine and a tensor mapping unit, the method comprising:
generating, by the processing engine, an instruction that is used to compute an output of the ML model,
wherein the instruction is executable at the integrated circuit to cause performance of operations comprising:
generating, by the tensor mapping unit, a plurality of tensor element positions for a tensor based on the instruction;
determining, by the tensor mapping unit, that a first subset of the plurality of tensor element positions is assigned to a first compute tile of the integrated circuit; and
generating, by the tensor mapping unit, control signals to obtain a group of inputs from a tile memory of the first compute tile based on the first subset.

14. The method of claim 13, wherein generating the plurality of tensor element positions comprises:
generating the plurality of tensor element positions by performing an affine transformation on an input image based on the instruction generated by the processing engine.

15. The method of claim 13, wherein the integrated circuit comprises a plurality of compute tiles and the method comprises:
determining, by the tensor mapping unit, an allocation of different subsets of the plurality of tensor element positions to one or more of the plurality of compute tiles.

16. The method of claim 15, wherein the tensor mapping unit comprises a first tensor module that:
generates the plurality of tensor element positions; and
generates, based on one or more instructions from the processing engine, a plurality of tensor element positions for each of a plurality of tensors.

17. The method of claim 16, wherein the tensor mapping unit comprises a plurality of second tensor modules and the method comprises:
generating, by the plurality of second tensor modules, control signals for obtaining data corresponding to the plurality of tensor element positions; and
processing the plurality of tensors at the integrated circuit using each second tensor module and each of the plurality of compute tiles.

18. The method of claim 17, further comprising:
generating, by the tensor mapping unit, a tensor mapping table that includes mapping information specific to:
i) the plurality of tensor element positions;
ii) multiple subsets of the plurality of tensor element positions; and
iii) an assignment of the first subset to the first compute tile.

19. The method of claim 17, further comprising:
determining, by the tensor mapping unit, a mapping of a first set of addresses of a virtual address space to a second, different set of addresses of a physical address space.

20. The method of claim 17, wherein:
the first tensor module is coupled to the processing engine and is external to each of the plurality of compute tiles;
a second tensor module of the plurality of second tensor modules is located at each compute tile of the plurality of compute tiles included at the integrated circuit;
each second tensor module is configured to access a tile memory of the compute tile that includes that second tensor module; and
that second tensor module accesses the tile memory based on a particular subset of the plurality of tensor element positions that is assigned to that compute tile.
